(19) United States
(12) Patent Application Publication
(10) Pub. No.: US 2009/0203255 A1
(43) Pub. Date: Aug. 13, 2009

(54) Mini-coaxial cable connector

(76) Inventor: Jun-Sung Chu, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,875

(22) Filed: Feb. 13, 2008

(51) Int. Cl. H01R 9/05

(52) U.S. Cl. 439/578

(57) ABSTRACT

A mini-coaxial cable connector includes a metal case having a cylindrical sleeve, two horizontally extended restricting arms, and a bendable clamping section having several pairs of clamping plates; an insulating seat having a hollow body located in the cylindrical body of the metal case, a holding-down strip, and a cable holder opposite to the holding-down strip and having the same length as that of the restricting arms for fitly locating in and between the restricting arms; and a contact terminal having two downward contact plates located in the hollow body and two horizontally staggered upward riveting plates for enclosing and riveting a center conductor of a coaxial cable. When the clamping section is bent, the pairs of clamping plates separately clamp around the cylindrical sleeve, the restricting arms, and the coaxial cable. And, the clamping plates clamping the restricting arms define a five-face damper having one open side.

### FIELD OF THE INVENTION

The present invention relates to a mini-coaxial cable connector, and more particularly, to a mini-coaxial cable connector that has minimized air clearances after being fully assembled to a coaxial cable to thereby prevent a signal transmitted via the connector and the coaxial cable from distortion.

### BACKGROUND OF THE INVENTION

FIGS. 1 and 2 are sectioned side views showing a conventional mini-coaxial cable connector before and after being assembled to a coaxial cable 3. As shown, the conventional mini-coaxial cable connector includes an insulating seat 1 and a metal case 2.

The insulating seat 1 includes a vertically extended and substantially cylindrical hollow body 11, a holding-down strip 12 extended from an upper outer edge of the hollow body 11, a vertically extended receiving space 13 defined in the hollow body 11, and a cable holder 14 horizontally extended from one side of the hollow body 11 opposite to the holding-down strip 12.

A contact terminal 15 is mounted in the hollow body 11. A pair of contact plates 151 is downward extended from a bottom of the contact terminal 15 to locate in the receiving space 13 of the hollowing body 11, and a curved pressing plate 152 is formed on a top of the contact terminal 15.

The metal case 2 includes a vertically extended cylindrical sleeve 21, which internally defines a clamping space 211 and has two restricting arms 212 horizontally extended from one side thereof; and a clamping section 22, which is upward extended from an upper outer edge of the cylindrical sleeve 21 opposite to the restricting arms 212. The clamping section 22 and the cylindrical sleeve 21 are integrally formed by way of pressing with a hinge portion 23 formed between them, so that the clamping section 22 may be bent about the hinge portion 23 relative to the cylindrical sleeve 21. The clamping section 22 is provided at two lateral sides with a first, a second, and a third pair of clamping plates 221, 222, 223.

The coaxial cable 3 includes from inner to outer side a center conductor 31, an insulating spacer 32, a braided conducting sheath 33, and an insulating outer sheath 34.

To assemble the conventional mini-coaxial cable connector to the coaxial cable 3, first position the insulating seat 1 and the contact terminal 15 in the clamping space 211 of the metal case 2 with the cable holder 14 of the insulating seat 1 located between the two restricting arms 212 of the metal case 2. Then, position the coaxial cable 3 on a top of the insulating seat 1 with the center conductor 31 of the coaxial cable 3 bearing against the contact terminal 15. Thereafter, use a suitable tool to bend the initially vertical clamping section 22 of the metal case 2 into a horizontal position to cover and press against the coaxial cable 3, and cause the clamping section 22, the holding-down strip 12, and the pressing plate 152 of the contact terminal 15 to firmly press against the center conductor 31 of the coaxial cable 3 and hold the center conductor 31 in place, so that the center conductor 31 is clamped by the contact terminal 15. Finally, cause the first, the second, and the third pair of clamping plates 221, 222, 223 located at two lateral sides of the clamping section 22 to firmly enclose and clamp around the restricting arms 212 extended from the cylindrical sleeve 21, the braided conducting sheath 33 of the coaxial cable 3, and the insulating outer sheath 34 of the coaxial cable 3, respectively, to complete the assembling of the conventional mini-coaxial cable connector to the coaxial cable 3.

In the above-described conventional mini-coaxial cable connector, the cable holder 14 on the insulating seat 1 is shorter than the restricting arms 212 on the metal case 2. When the first pair of clamping plates 221 of the clamping section 22 is enclosed and clamped around the restricting arms 212, an inner side of the restricting arms 212 is not fully filled by the cable holder 14 to thereby have large and significant air clearance therein. The large air clearance tends to cause distortion of a high-frequency signal transmitted via the connector and the coaxial cable 3. Moreover, when the above-described conventional mini-coaxial cable connector is assembled to the coaxial cable 3, the center conductor 31 of the coaxial cable 3 is clamped only at upper and lower sides by the pressing plate 152 of the contact terminal 15. Since the pressing plate 152 provides only a limited clamping force against the center conductor 31, a poor contact between the center conductor 31 and the contact terminal 15 tends to occur to adversely affect the quality of signal transmitted via the connector and the coaxial cable.

It is therefore tried by the inventor to develop an improved mini-coaxial cable connector to overcome the drawbacks in the conventional mini-coaxial cable connector.

### SUMMARY OF THE INVENTION

A primary object of the present invention is to provide a mini-coaxial cable connector that has minimized air clearances after being fully assembled to a coaxial cable, so as to prevent a signal transmitted via the connector and the coaxial cable from distortion and ensure good signal transmission quality.

To achieve the above and other objects, the mini-coaxial cable connector according to the present invention includes a metal case, an insulating seat, and a contact terminal. The metal case includes a cylindrical sleeve internally defining a clamping space, a pair of restricting arms horizontally extended from one side of the cylindrical sleeve, and a bendable clamping section upward extended from an upper outer edge of the cylindrical sleeve opposite to the side with the restricting arms. The clamping section is provided at two lateral sides with a plurality of clamping plates. The insulating seat includes a hollow body received in the clamping space of the metal case, a holding-down strip upward extended from an upper outer edge of the hollow body, a receiving space defined in the hollow body, and a cable holder horizontally extended from one side of the hollow body opposite to the holding-down strip. The cable holder is received in and between the two restricting arms, and has a length the same as that of the restricting arms. The contact terminal is provided at a bottom with a pair of contact plates for locating in the receiving space of the insulating seat, and at a top with two horizontally staggered riveting plates for enclosing and riveting around a center conductor of a coaxial cable. When the clamping section of the metal case is bent, the clamping plates on the clamping section separately firmly clamp around the cylindrical sleeve, the restricting arms, and the coaxial cable. Since the cable holder and the restricting arms have the same length, the cable holder may fully fill an inner side of the two restricting arms. Therefore, when the clamping plates on the metal case firmly clamp around the two restricting arms, there is only a smooth and minimized air clearance between the cable holder and the restricting arms to ensure a stable structure of the connector and protect a transmitted signal against distortion.

In the present invention, the clamping plates for clamping the restricting arms define a five-face damper having one open side. There are four angles defined in the five-face damper to match external angles on the restricting arms of the metal case, allowing the clamping plates to fitly clamp around the restricting arms to minimize the air clearance between the clamping plates and the restricting arms as well as between the restricting arms and the cable holder.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectioned side view of a conventional mini-coaxial cable connector;

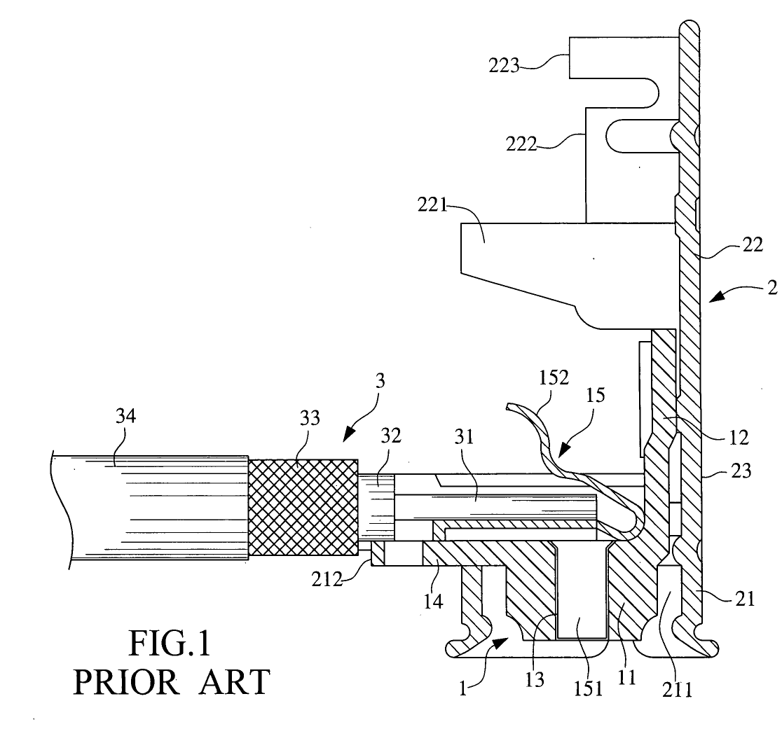

FIG. 2 is a sectioned side view showing the conventional mini-coaxial cable connector of FIG. 1 having been assembled to a mini-coaxial cable;

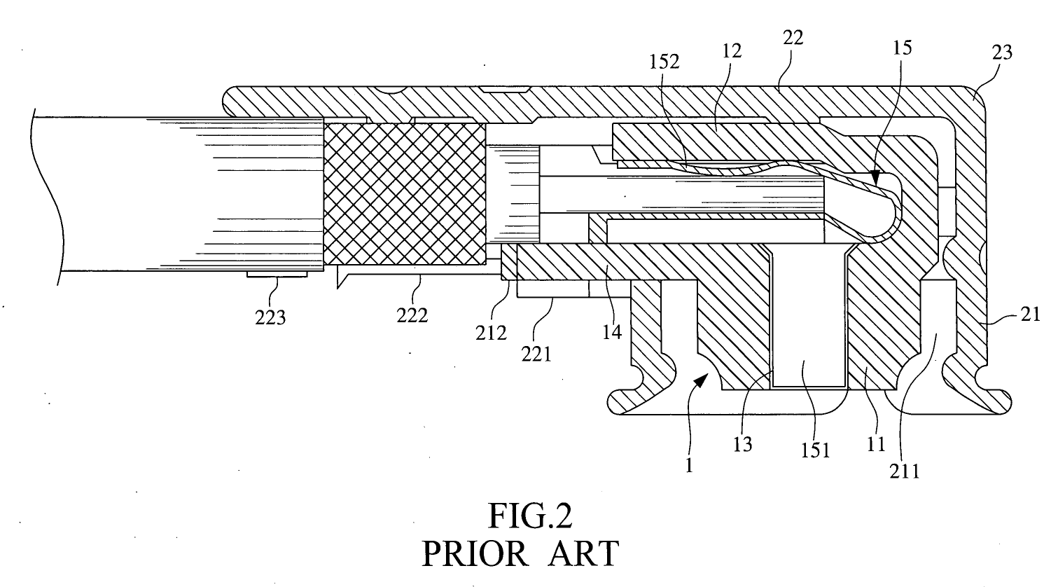

FIG. 3 is an exploded perspective view of a mini-coaxial cable connector according to the present invention;

FIG. 4 shows the first step of assembling the mini-coaxial cable connector of FIG. 3 to a mini-coaxial cable;

FIG. 5 shows the second step of assembling the mini-coaxial cable connector of FIG. 3 to the mini-coaxial cable;

FIG. 6 is an assembled perspective view showing the mini-coaxial cable connector of FIG. 3 has been fully assembled to the mini-coaxial cable;

FIG. 7 is a sectioned side view of FIG. 5; and

FIG. 8 is a sectioned side view of FIG. 6.

### DETAILED DESCRIPTION OF THE PREFERRED EMBODIMENTS

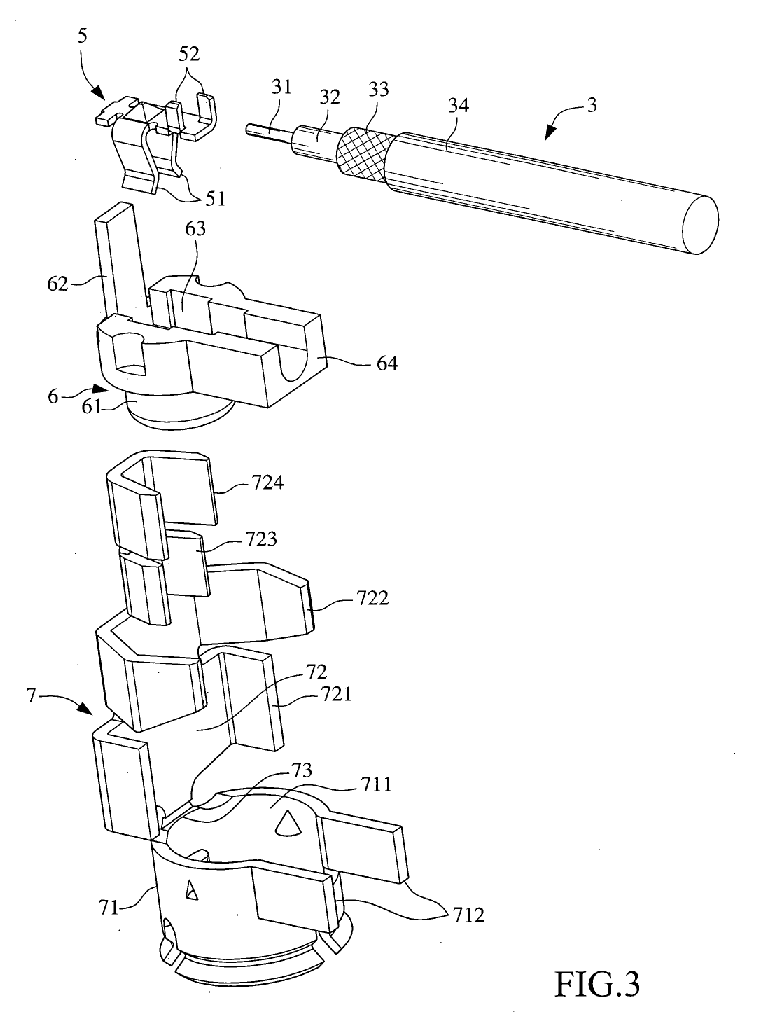

Please refer to FIGS. 3 to 6. A mini-coaxial cable connector according to the present invention includes a contact terminal 5, an insulating seat 6, and a metal case 7.

The contact terminal 5 is provided at a bottom with a pair of downward extended contact plates 51, and at a top with two upward extended riveting plates 52 arranged in staggered relation to each other in a horizontal direction. The two staggered riveting plates 52 may apply two horizontally spaced enclosing and riveting forces against a center conductor 31 of a coaxial cable 3 to firmly clamp on the center conductor 31 without damaging the same.

The insulating seat 6 includes a vertically extended and substantially cylindrical hollow body 61, a holding-down strip 62 upward extended from an upper outer edge of the cylindrical hollow body 61, a receiving space 63 defined in the cylindrical hollow body 61 to vertically extend through the hollow body 61, and a cable holder 64 horizontally extended from one side of the hollow body 61 opposite to the holding-down strip 62 for holding a length of center conductor 31 and insulating spacer 32 of the coaxial cable 3 therein. The cable holder 64 is extended from the hollow body 61 by a length the same as a length of two restricting arms 712 on the metal case 7, which will be described later herein.

The metal case 7 includes a vertically extended cylindrical sleeve 71, which internally defines a clamping space 711 vertically extended therethrough and has two restricting arms 712 horizontally extended from one side thereof to laterally space from each other by a predetermined distance for receiving and confining the cable holder 64 therein, the restricting arms 712 having a length the same as that of the cable holder 64; and a clamping section 72 upward extended from an upper outer edge of the cylindrical sleeve 71 opposite to the side with the two restricting arms 712. The clamping section 72 and the cylindrical sleeve 71 is integrally formed by way of pressing with a hinge portion 73 formed therebetween, so that the clamping section 72 may be bent about the hinge portion 73 to clamp the coaxial cable 3 in the mini-coaxial cable connector. The clamping section 72 is provided at two lateral sides from bottom to top with a pair of first clamping plates 721, a pair of second clamping plates 722, a pair of third clamping plates 723, and a pair of fourth clamping plates 724.

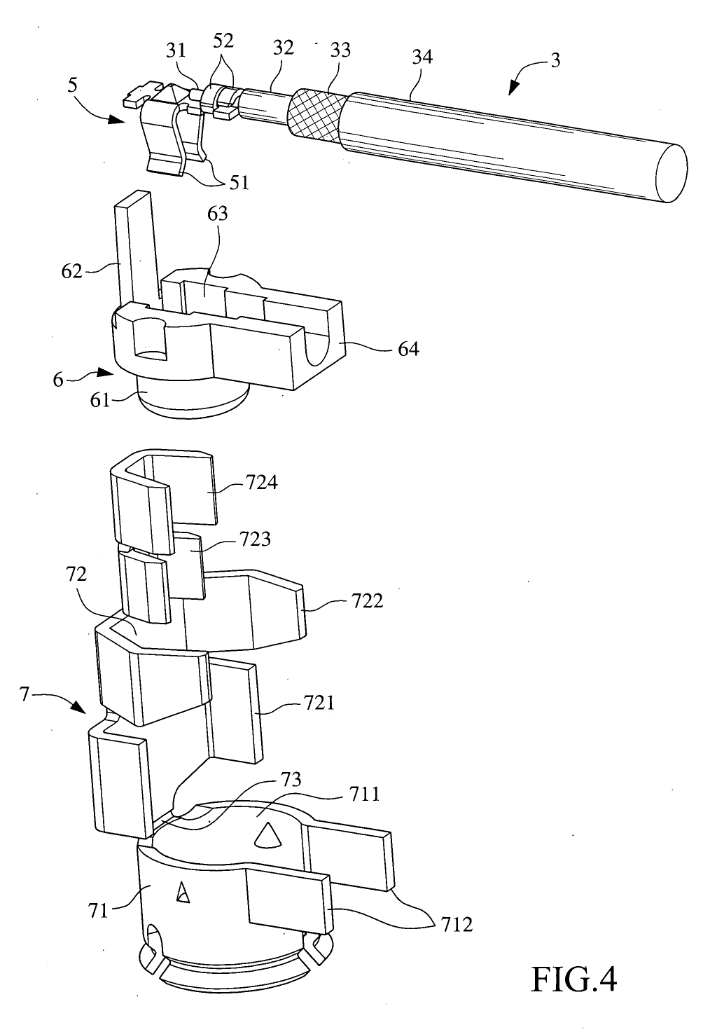

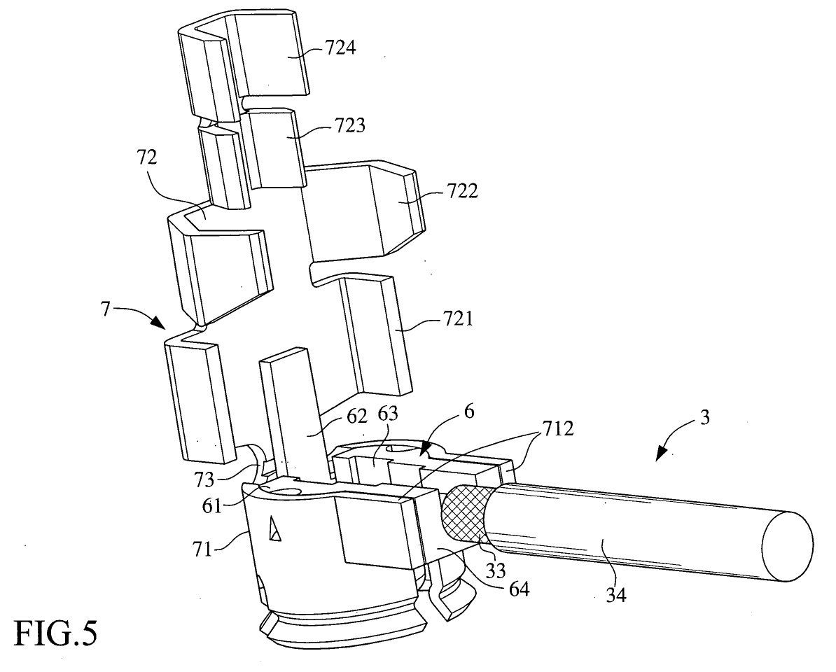

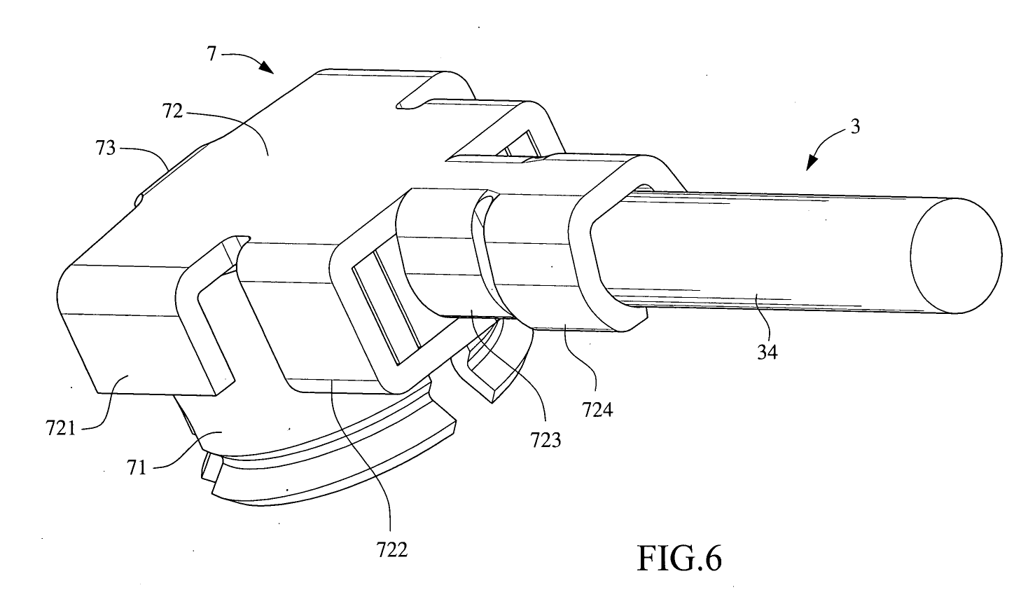

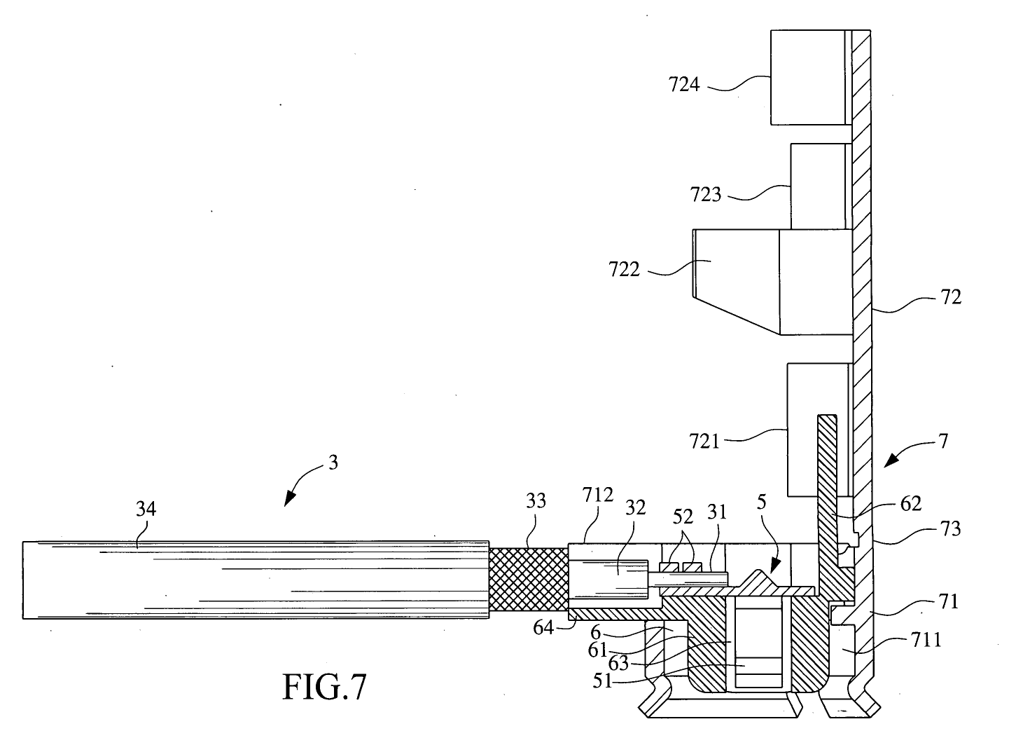

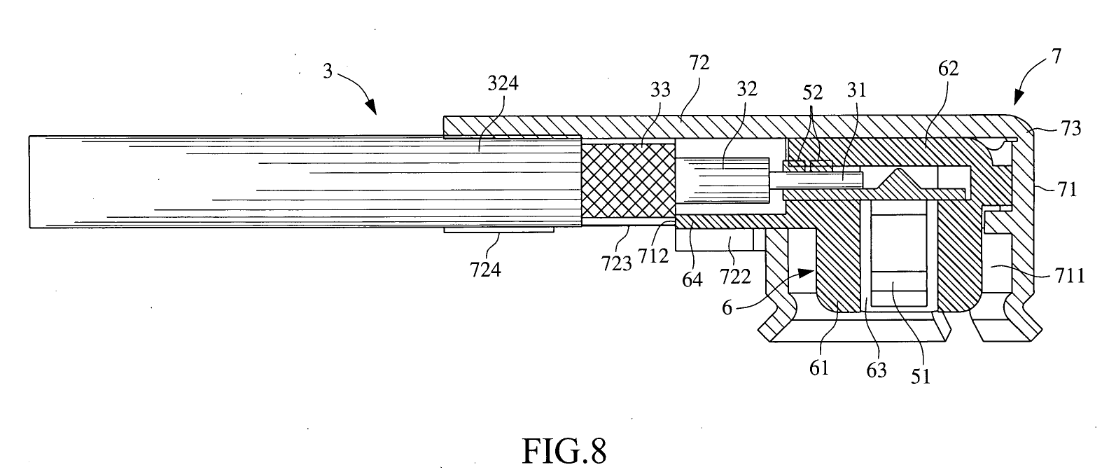

FIGS. 7 and 8 are sectioned side views showing the assembling of the mini-coaxial cable connector of the present invention to the coaxial cable 3. First, the riveting plates 52 of the contact terminal 5 are inward bend to rivet and clamp the center conductor 31 of the coaxial cable 3, as shown in FIG. 4; then the contact terminal 5 with the coaxial cable 3 connected thereto is positioned in the insulating seat 6 with the two contact plates 51 located in the receiving space 63 in the cylindrical hollow body 61 of the insulating seat 6; and then the insulating seat 6 along with the contact terminal 5 are positioned in the clamping space 711 of the metal case 7, as shown in FIGS. 5 and 7. Finally, a suitable tool is used to bend the initially vertical clamping section 72 of the metal case 7 into a horizontal position to apply a pressing force against the coaxial cable 3. At this point, the first clamping plates 721, the second clamping plates 722, the third clamping plates 723, and the fourth clamping plates 724 at two lateral sides of the clamping section 72 are separately tightly clamped around the cylindrical sleeve 71, the restricting arms 712 extended from the cylindrical sleeve 71, a length of braided conducting sheath 33 of the coaxial cable 3, and a length of insulating outer sheath 34 of the coaxial cable 3 to complete the assembling of the mini-coaxial cable connector of the present invention to the coaxial cable 3, as shown in FIGS. 6 and 8.

After being fully assembled to the coaxial cable 3, the mini-coaxial cable connector of the present invention provides the same connecting effect as general coaxial cable connectors. That is, the holding-down strip 62 of the insulating seat 6 is located between the contact terminal 5 and the metal case 7 to provide an insulating effect; the clamping section 72 of the metal case 7 firmly clamps around the braided conducting sheath 33 of the coaxial cable 3 to provide a grounding effect; and the center conductor 31 of the coaxial cable 3 may be electrically connected to another device via the contact terminal 5 and the receiving space 63.

In addition, in the present invention, the cable holder 64 of the insulating seat 6 is designed to have the same length as that of the restricting arms 712 of the metal case 7, so as to be completely and fitly received in a space between the two restricting arms 712. In this manner, when the two second clamping plates 722 together clamp around the two restricting arms 712, a smooth and minimized air clearance between the restricting arms 712 and the cable holder 64 may be achieved to ensure that a signal transmitted via the coaxial cable 3 is not subject to distortion at the mini-coaxial cable connector. Moreover, with the horizontally staggered riveting plates 52 of the contact terminal 5, the center conductor 31 of the coaxial cable 3 is more stably held to the contact terminal 5 by two spaced enclosing and riveting forces from the two staggered riveting plates 52. The provision of two horizontally staggered riveting plates 52 also avoids the problem of having too long or too short riveting plates that tend to break or undesirably scratch the center conductor 31.

In the present invention, the second clamping plates 722 extended from two lateral sides of the clamping section 72 together define a five-face damper with one open side. There are four angles defined in the five-face damper to match external angles on the restricting arms 712 of the metal case 7, so that the second clamping plates 722 may clamp around the restricting arms 712 to minimize the air clearance between the clamping plates 722 and the restricting arms 712 as well as between the restricting arms 712 and the cable holder 64.

The present invention has been described with a preferred embodiment thereof and it is understood that many changes and modifications in the described embodiment can be carried out without departing from the scope and the spirit of the invention that is intended to be limited only by the appended claims.

1. A mini-coaxial cable connector for assembling to a coaxial cable having a center conductor, an insulating spacer, a braided conducting sheath, and an insulating outer sheath from inner to outer side, comprising:
a metal case including a vertically extended cylindrical sleeve internally defining a clamping space and having two restricting arms horizontally extended from one side thereof; and a clamping section integrally extended from an upper outer edge of the cylindrical sleeve opposite to the side with the restricting arms; the clamping section being bendable about a hinge portion formed on the metal case between the clamping section and the cylindrical sleeve, and being provided at two lateral sides from bottom to top with a first, a second, a third, and a fourth pair of clamping plates;
an insulating seat including a vertically extended cylindrical hollow body positioned in the clamping space of the metal case, a holding-down strip extended from an upper outer edge of the cylindrical hollow body, a receiving space defined in the cylindrical hollow body, and a cable holder horizontally extended from one side of the hollow body opposite to the holding-down strip; the cable holder being positioned in and between the two restricting arm of the metal case for receiving a front length of the coaxial cable therein; and the cable holder having a length substantially the same as the restricting arms; and
a contact terminal provided at a bottom with a pair of contact plates positioned in the receiving space of the insulating seat, and at a top with two horizontally staggered riveting plates extending from a contact surface, the riveting plates extending respectively over and clamping against the contact surface axially offset portions of the center conductor of the coaxial cable; and
wherein when the clamping section of the metal case is bent about the hinge portion into a horizontal position, the first, the second, the third, and the fourth pair of clamping plates separately clamp around the cylindrical sleeve, the restricting arms, a length of the braided conducting sheath of the coaxial cable, and a length of the insulating outer sheath of the coaxial cable.

2. The mini-coaxial cable connector as claimed in claim 1, wherein the second pair of clamping plates extended from two lateral sides of the clamping section defines a five-face damper with one open side, and the five-face damper internally defines four angles matching external angles on the restricting arms of the metal case.
